(19) United States
(12) Patent Application Publication
(10) Pub. No.: US 2023/0146275 A1
(43) Pub. Date: May 11, 2023

(54) Computer Vision-Based Dynamic Radio Frequency Planning and Optimization

(71) Applicant: AT&T Intellectual Property I, L.P., Atlanta, GA (US)

(72) Inventor: Sreejith Menon, Herndon, VA (US)

(73) Assignee: AT&T Intellectual Property I, L.P., Atlanta, GA (US)

(21) Appl. No.: 17/523,968

(22) Filed: Nov. 11, 2021

(51) Int. Cl. H04W 16/18; H04W 16/22; H04B 17/391

(52) U.S. Cl. CPC H04W 16/18; H04W 16/22; H04B 17/3912

(57) ABSTRACT

Concepts and technologies disclosed herein are directed to computer vision-based dynamic radio frequency (“RF”) planning and optimization. According to one aspect disclosed herein, a system can monitor cell site data from a cell site. The system can determine that the cell site data represents a change to the cell site. In response to determining that the cell site data represents the change to the cell site, the system can update clutter data associated with the cell site to reflect the change. The system can determine a potential RF signal attenuation associated with the object. The system can then determine that the potential RF signal attenuation associated with the object meets or exceeds a threshold. The system can trigger a remedial action to mitigate the potential RF signal attenuation.

### BACKGROUND

Radio frequency (“RF”) planning, deployment, and optimization is a time-consuming, expensive, and tedious process for mobile network operators. As radio access network (“RAN”) technologies evolve, resulting in changes to the underlying cell site deployment strategies, these processes will become more complex and expensive. Moreover, regular RAN optimization requires a significant amount of manual drive testing, log analysis, and clutter data analysis from third party sources, which adds to the time-consuming and tedious nature of these processes.

### SUMMARY

Concepts and technologies disclosed herein are directed to computer vision-based dynamic RF planning and optimization. According to one aspect disclosed herein, a system can monitor cell site data received from a cell site. The system can determine that the cell site data represents a change to the cell site. In response to determining that the cell site data represents the change to the cell site, the system can update clutter data associated with the cell site to reflect the change. The system can determine a potential RF signal attenuation associated with the object. The system can then determine that the potential RF signal attenuation associated with the object meets or exceeds a threshold. The system can trigger a remedial action to mitigate the potential RF signal attenuation.

In some embodiments, the system can obtain model training data to train the image recognition model. The system can train the image recognition model based, at least in part, upon the model training data. The model training data can include a plurality of baseline cell site images.

In some embodiments, the cell site data can include a cell site image captured by a camera located at the cell site. Additionally or alternatively, the cell site data can include sensor data captured by a sensor located at the cell site. In some embodiments, the system can determine a density of the object. The potential RF signal attenuation is based, at least in part, upon the density of the object.

In some embodiments, the remedial action can be or can include a remote antenna adjustment to an antenna array of an antenna system deployed at the cell site, such as a change that affects the azimuth value and/or the tilt value of one or more antennas in the antenna array. The remedial action can be or can include a change to the transmit power of a base station. The remedial action can be or can include a deployment of additional cell resources, such as temporary small cells, which may be terrestrial or aerial (e.g., drone-based). Those skilled in the art will appreciate that other remedial actions can be taken to mitigate or eliminate the effects caused by the change at the cell site.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating aspects of an illustrative operating environment in which the concept and technologies disclosed herein can be implemented.

FIG. 2 is a block diagram illustrating aspects of an illustrative RF planning and optimization system capable of implementing aspects of the embodiments presented herein.

FIG. 3 is a block diagram illustrating aspects of an illustrative combined eNB/gNB capable of implementing aspects of the embodiments presented herein.

FIGS. 4A-4C are flow diagrams illustrating a method for computer vision-based RF planning and optimization, according to an illustrative embodiment.

FIG. 5 is a block diagram illustrating an example mobile device, according to an illustrative embodiment.

FIG. 6 is a block diagram illustrating an example computer system capable of implementing aspects of the embodiments presented herein.

FIG. 7 is a diagram illustrating a network, according to an illustrative embodiment.

FIG. 8 is a block diagram illustrating a machine learning system capable of implementing aspects of the concept and technologies disclosed herein.

FIG. 9 is a block diagram illustrating a virtualized cloud architecture capable of implementing aspects of the concepts and technologies disclosed herein.

### DETAILED DESCRIPTION

While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer systems, including hand-held devices, mobile devices, wireless devices, multiprocessor systems, distributed computing systems, microprocessor-based or programmable consumer electronics, minicomputers, mainframe computers, routers, switches, other computing devices described herein, and the like.

In the following detailed description, references are made to the accompanying drawings that form a part hereof, and in which are shown by way of illustration specific embodiments or examples. Referring now to the drawings, in which like numerals represent like elements throughout the several figures, aspects of concepts and technologies for computer-vision based dynamic RF planning and optimization will be described.

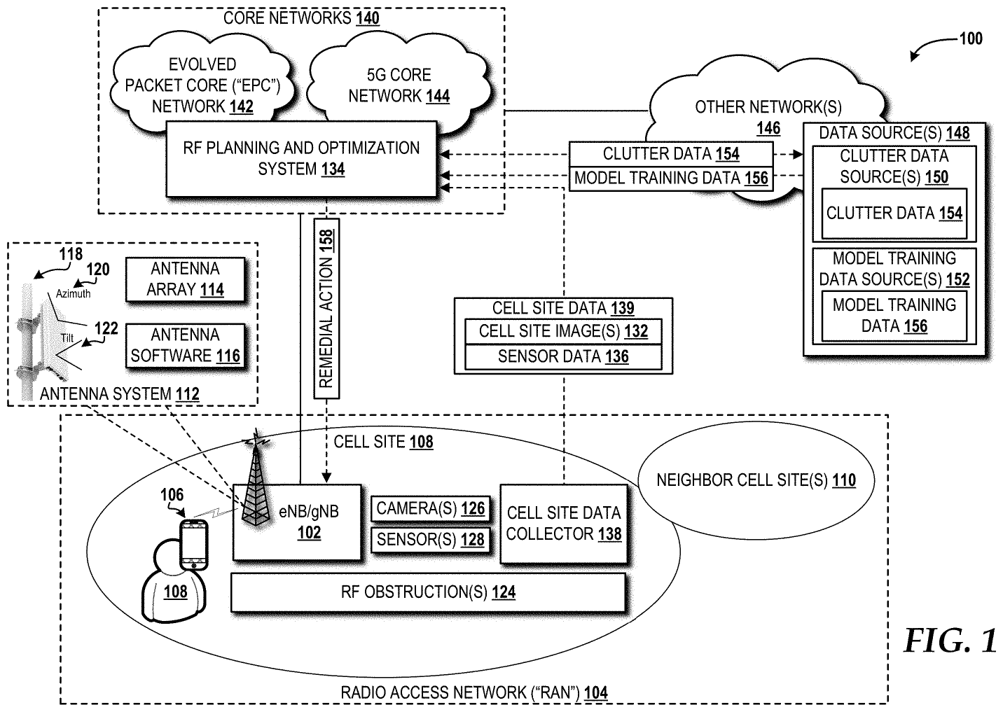

Referring now to FIG. 1, an illustrative operating environment 100 in which the concepts and technologies disclosed herein can be implemented will be described. The operating environment 100 includes a combined Evolved Node Base eNodeB (“eNB”) and mmWave Next Generation Node Base (“gNB”), which is shown as eNB/gNB 102 operating as part of a radio access network (“RAN”) 104. The eNB/gNB 102 and the RAN 104 can be configured in accordance with one or more 3GPP technical specifications for next generation (“5G”) RAN architecture, combined 4G/5G RAN architecture, or any revision thereof.

The eNB/gNB 102 can provide a radio/air interface over which one or more mobile devices, such as a mobile device 106 associated with a user 107 (e.g., a subscriber of a mobile telecommunications service—data, voice, or both), can connect to the RAN 104. The mobile device 106 may be a cellular phone, a feature phone, a smartphone, a mobile computing device, a tablet computing device, a portable television, a portable video game console, or any other computing device that includes one or more radio access components that are capable of connecting to and communicating with one or more RANs, such as the RAN 104, via one or more radio access components. In some embodiments, the mobile device 106 includes an integrated or external radio access component that facilitates wireless communication with one or more RANs, such as the RAN 104. The radio access component may be a cellular telephone that is in wired or wireless communication with the mobile device 106 to facilitate a tethered data connection to one or more RANs, such as the RAN 104. Alternatively, the radio access component includes a wireless transceiver configured to send data to and receive data from one or more RANs and a universal serial bus (“USB”) or another communication interface for connection to the mobile device 106 so as to enable tethering. In any case, the mobile device 106 can wirelessly communicate with one or more RANs over a radio/air interface in accordance with one or more radio access technologies (“RATs”). The mobile device 106 may also initiate, receive, and maintain voice calls with one or more other voice-enabled telecommunications devices, such as other mobile devices or landline devices (not shown). The mobile device 106 may also exchange Short Message Service (“SMS”) messages, Multimedia Message Service (“MMS”) messages, email, and/or other messages with other devices (not shown).

In the illustrated example, the eNB/gNB 102 provides dual connectivity for the mobile device 106 to access an LTE cell and a 5G-NR cell of a cell site 108. Similarly, one or more additional eNB/gNBs (not shown) can provide dual connectivity for the mobile device 106 to access one or more additional LTE cells and 5G-NR cells, such as part of one or more neighbor cell sites 110, as the mobile device 106 moves throughout an area served by the RAN 104. The LTE cell is a geographical area served by the eNB portion of the eNB/gNB 102. The 5G-NR cell is a geographical area served by the gNB portion of the eNB/gNB 102. A mobile network operator (“MNO”) can install the eNB/gNB 102 and other eNB/gNBs 102 (e.g., at the neighbor cell sites 110) to provide network access for the mobile device 106 (and/or other devices that are not shown) in specific geographic locations. The remaining description will focus on a single eNB/gNB 102 that provides network access for the mobile device 106 within the geographical areas served by the LTE cell and the 5G-NR cell as part of the cell site 108.

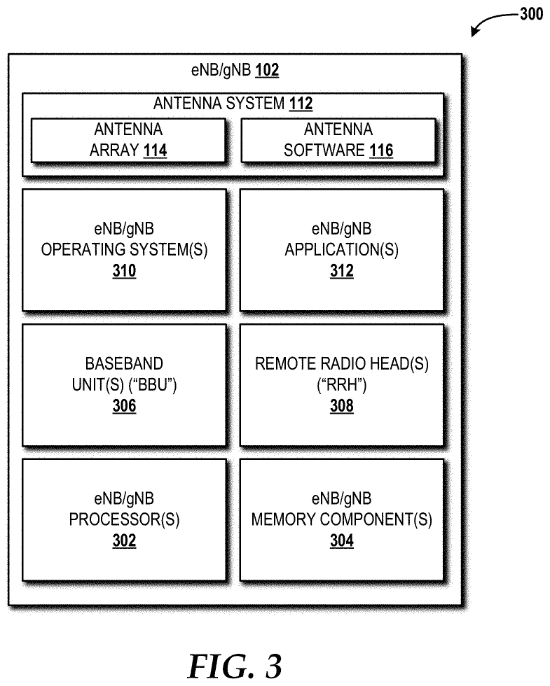

The eNB/gNB 102 can include one or more LTE radio components and one or more 5G-NR radio components to generate radio waves to be broadcast by an antenna system 112. A more detailed eNB/gNB architecture is illustrated and described herein with reference to FIG. 3. The antenna system 112 can include an antenna array 114 and antenna software 116. The antenna array 114 can be configured in accordance with any antenna design specifications to provide a physical interface for receiving and transmitting radio waves as one or more beams to and from one or more devices, such as the mobile device 106. The antenna array 114 can be designed or selected (e.g., off-the-shelf) based upon the needs of a given implementation. Proprietary designs for the antenna array 114 are contemplated, as well as those that are commercially available to mobile network operators (e.g., from one or more vendors). The antenna array 114 can include any number of antenna elements arranged in rows and columns. Each antenna element can be dually-polarized. The antenna array 114 can be divided into a plurality of sub-arrays. The antenna array 114 can be any size and any shape. The antenna array 114 can be programmed via the antenna software 116, such as to set or change the gain of the antenna array 114 or a specific portion thereof to achieve a desired radiation pattern. The antenna software 116 can be proprietary or commercially available software that is provided as part of the antenna array 114 or is otherwise available from a vendor or the open source community.

In the illustrated example, the antenna system 112 is configured in an antenna configuration 118 to provide optimal coverage for devices, such as the mobile device 106, operating within the cell site 108. The antenna configuration 118 can define how the antenna array 114 is positioned based upon an azimuth (horizontal) value 120 and a tilt (vertical) value 122. As will be described herein, the antenna configuration 118 can be changed to mitigate, at least in part, RF signal attenuation caused by one or more RF obstructions 124 deployed at the cell site 108. For example, the antenna software 116 can receive instructions to change the azimuth value 120 and/or the tilt value 122 of the antenna configuration 118.

The illustrated cell site 108 has been upgraded to include one or more cameras 126 and one or more sensors 128 to enable computer vision-based dynamic RF planning and optimization in accordance with the concepts and technologies disclosed herein. In particular, the camera(s) 126 can capture one or more cell site images 132 as part of a monitoring operation controlled by an RF planning and optimization system 134. The cell site images 132 can be used by the RF planning and optimization system 134 to determine whether a change has occurred at the cell site 108 resulting in the RF obstruction(s) 124 causing RF signal attenuation, which can lead to poor or no signal at the mobile device 106 (and other devices operating in the cell site 108), dropped calls, reduced bandwidth, or an otherwise degraded experience for the user 107. The sensor(s) 128 can optionally be used to determine identifying characteristics of one or more objects causing the RF obstruction(s) 124. For example, the sensor(s) 128 can be or can include one or more lidar sensors that can be used to detect the RF obstruction(s) 124 and/or obtain data to interpret a density of the RF obstruction(s) 124, which can aid in determining an object type, such as a building or other structure (e.g., a temporary structure such as a tent), a vehicle, a tree, a pedestrian, or other object. Output of the sensor(s) 128 is shown as sensor data 136.

The cell site 108 can include a cell site data collector 138 that is configured to aggregate output of the camera(s) 126 and the sensor(s) 128 (shown as cell site data 139) for sending to the RF planning and optimization system 134. In some embodiments, the cell site data collector 138 may prepare the cell site data 139, including compressing the cell site data 139, formatting the cell site data 139, encrypting the cell site data 139, or otherwise manipulating the cell site data 139 prior to transferring the cell site data 139 to the RF planning and optimization system 134. In some embodiments, the cell site data collector 138 provides the cell site data 139 to the RF planning and optimization system 134 via a dedicated channel. It is contemplated that the cell site data collector 138 may provide the cell site data 139 to the RF planning and optimization system 134 via a backhaul connection, which may be shared with other backhaul communications or dedicated for providing the cell site data 139 to the RF planning and optimization system 134.

The eNB/gNB 102 is shown as being in communication with core networks 140, including an evolved packet core (“EPC”) network 142 and a 5G core network 144. The core networks 140 are, in turn, in communication with one or more other networks 146 such as one or more other public land mobile networks (“PLMNs”), one or more packet data networks (“PDNs”) (e.g., the Internet), combinations thereof, and/or the like. The mobile device 106 can access services (not shown) provided through the other network(s) 146.

The eNB/gNB 102 can connect to the EPC network 142 via an S1 interface, and more specifically to a mobility management entity (“MME”) (not shown) via an S1-MME, and to a serving gateway (“S-GW”) (not shown) via an S1-U interface. The EPC network 142 can include one or more MMES, one or more S-GW (which may be combined with one or more packet gateways (“P-GWs”), and one or more home subscriber servers (“HSS”). Although not shown in the illustrated example, the EPC network 142 can include these network elements and may additionally include other network elements not specifically mentioned herein. In general, the EPC network 142 can be established based upon 3GPP standards specifications.

The core network components of the EPC network 142 can be implemented as physical network functions (“PNFs”) having hardware and software components. The core network components of the EPC network 142 can additionally or alternatively be provided, at least in part, by virtual network functions (“VNFs”). For example, the core network components can be realized as VNFs that utilize a unified commercial-of-the-shelf (“COTS”) hardware and flexible resources shared model with the application software for the respective core network components running on one or more virtual machines (“VMs”). Moreover, the core network components can be embodied as VNFs in one or more VNF pools, each of which can include a plurality of VNFs providing a particular core network function.

An MME can be configured in accordance with 3GPP standards specifications and can perform operations to control signaling traffic related to mobility and security for access to the eNB portion of the eNB/gNB 102 via the S1-MME interface. The MME also can be in communication with an HSS via an Sha interface and a combined S/PGW via an S11 interface. These interfaces are defined as part of 3GPP standards specifications.

An SGW and a PGW can be configured in accordance with 3GPP standards specifications. The SGW can provide a point of interconnect between the radio-side (e.g., the eNB portion of the eNB/gNB 102) and the EPC network 142. The SGW can serve devices by routing incoming and outgoing IP packets between the eNB portion of the eNB/gNB 102 and the EPC network 142. The PGW interconnects the EPC network 142 to the other networks 146. The PGW routes IP packets to and from the other network(s) 146. The PGW also performs operations such as IP address/prefix allocation, policy control, and charging. The SGW and the PGW can be in communication with the MME via an S11 interface and with the other network(s) 146 via an SGi interface. These interfaces are defined as part of 3GPP standards specifications.

An HSS can be configured in accordance with 3GPP standards specifications. The HSS is a database that contains user-related information for users of devices, such as the user 107 of the mobile device 106. The HSS can provide support functions to the MME for mobility management, call and data session setup, user authentication, and access authorization.

At the edge of the EPC network 142, the MME and S-GW can be connected over the IP-based S1 interface to the eNB/gNB 102. The eNB and the gNB are logically different components that can communicate with each other via a standardized IP interface (i.e., the X2 interface). If the eNB and gNB are combined into a single hardware node, such as in the illustrated example, the X2 interface is an internal interface (or logical interface) between the two components.

The 5G core network 144 can include network functions that provide functionality similar to that of the EPC network 142 for LTE but for 5G technologies such as mmWave. For example, current 3GPP standards define a 5G core network architecture as having an access and mobility management function (“AMF”) that provides mobility management functionality similar to that of an MME in the EPC network 142; a session management function (“SMF”) that provides session management functionality similar to that of an MME and some of the S/P-GW functions, including IP address allocation, in the EPC network 142; an authentication server function (“AUSF”) managed subscriber authentication during registration or re-registration with the 5G core network 144; and user plane function (“UPF”) combines the user traffic transport functions previously performed by the S/P-GW in the EPC network 142, among others. While 3GPP has defined some of these network functions, these network functions may be split into greater granularity to perform specific functions, may be combined, and/or additional functions may be added by the time the MNO deploys a live 5G network. As such, the 5G core network 144 is intended to encompass any and all 5G core network functions that are currently defined in technical specifications currently available and revisions thereof made in the future.

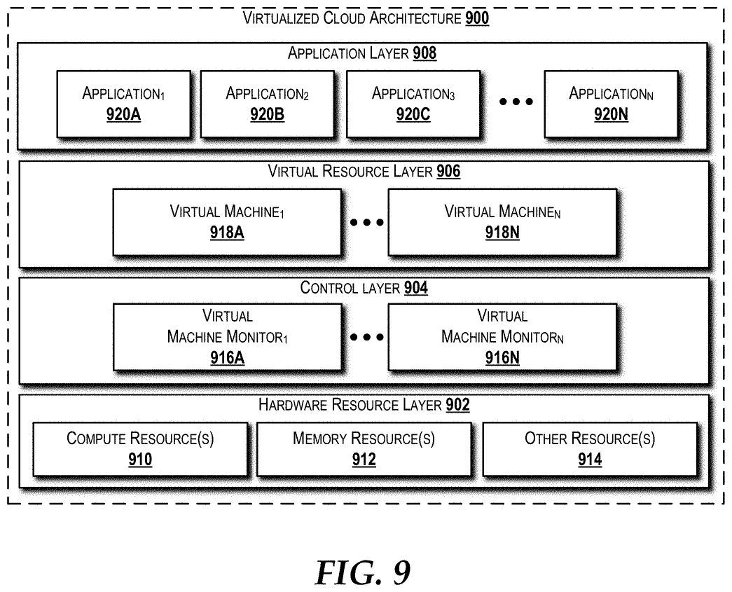

The core network elements of the core networks 140 can be implemented as PNFs having hardware and software components. The core network elements of the core networks 140 can additionally or alternatively be provided, at least in part, by VNFs supported by an underlying software-defined network (“SDN”) and network virtualization platform (“NVP”) architecture. For example, the core network elements can be realized as VNFs that utilize a unified commercial-of-the-shelf (“COTS”) hardware and flexible resources shared model with the application software for the respective core network components running on one or more virtual machines (“VMs”). Moreover, the core network elements can be embodied as VNFs in one or more VNF pools, each of which can include a plurality of VNFs providing a particular core network function. Similarly, elements of the RAN 104 can be implemented, at least in part, via VNFs. An example virtualized cloud architecture 900 that is capable of supporting virtualization technologies is described herein with reference to FIG. 9.

In the illustrated example, the RF planning and optimization system 134 is shown operating in the core networks 140. The RF planning and optimization system 134 may be implemented as part of the EPC 142 and/or part of the 5G core network 144. Alternatively, the RF planning and optimization system 134 may operate in communication with the EPC 142 and/or the 5G core network 144. The RF planning and optimization system 134 may be a standalone system dedicated to RF planning and optimization concepts described herein, or may be integrated with other functionality of the core networks 140. For example, the RF planning and optimization system 134 may be implemented as part of a self-organizing network software stack. The RF planning and optimization system 134 may be implemented on dedicated hardware or virtualized such as on the virtualized cloud architecture 900.

The RF planning and optimization system 134 can operate in communication with the other network(s) 146 to access one or more data sources 148, including one or more clutter data sources 150 and one or more model training data source(s) 152.

Additionally or alternatively, the RF planning and optimization system 134 may have local access to the data source(s) 148.

The clutter data sources 150 can include one or more databases or other data structures containing clutter data 154, which can be sent to the RF planning and optimization system 134. The clutter data sources 150 may be created and maintained by one or more third parties (e.g., vendors to the mobile network operator) and/or first party (i.e., the mobile network operator). Clutter data 154 is used herein to describe localized features of an environment, such as trees, buildings, houses, and other structures (e.g., temporary structures such as tents or ride equipment) that have an impact on the propagation of radio signals. These features are generally shown as RF obstructions 124 in the cell site 108. Typically, the clutter data 154 can be considered during a cell site planning process and may include data collected during drive testing in combination with map data (e.g., to create a heat map for the RAN 104). Events during which temporary structures are erected and remain in place for a period of time are not captured in the clutter data 154 used for cell site planning. As such, the radio propagation characteristics of the cell site 108 can be changed by these temporary structures. As such, the cell site 108 may, from time-to-time, have additional RF obstructions 124 during events (e.g., fairs, sporting events, trade shows, and the like) that are not properly accounted for by the clutter data 154.

The model training data source(s) 152 can include one or more databases or other data structures containing model training data 156, which can be sent to the RF planning and optimization system 134 during a model training process performed by the RF planning and optimization system 134. In some embodiments, the model training data 156 can be or can include baseline cell site image(s) of the cell site 108 and/or the neighbor cell site(s) 110 with a baseline of RF obstructions 124 (e.g., pre-existing trees, buildings, etc.). The baseline cell site image(s) can be associated with the clutter data 154 such that the RF planning and optimization system 134 can identify the RF obstructions 124 and can recognize additional RF obstructions 124, such as those erected temporarily for an event.

As will be described in further detail herein, the RF planning and optimization system 134 can recognize changes to the cell site 108 via the cell site data 139 obtained from the camera(s) 126 and, optionally, the sensor(s) 128. These changes may adversely affect radio signal propagation from the eNB/gNB 102 to/from the mobile device 106 and/or other device(s) (not shown). In some embodiments, the RF planning and optimization system 134 can instruct the eNB/gNB 102 to perform one or more remedial actions 158.

The remedial action(s) 158 can be or can include a remote antenna adjustment to the antenna array 114 of the antenna system 112 deployed at the cell site 108, such as a change that affects the azimuth value 120 and/or the tilt value 122 of one or more antennas in the antenna array 114. The remedial action(s) 158 can be or can include a change to the transmit power of the eNB/gNB 102. The remedial action(s) 158 can be or can include a deployment of additional cell resources, such as temporary small cells, which may be terrestrial or aerial (e.g., drone-based). Those skilled in the art will appreciate that other remedial actions 158 can be taken to mitigate or eliminate the effects caused by the change at the cell site 108.

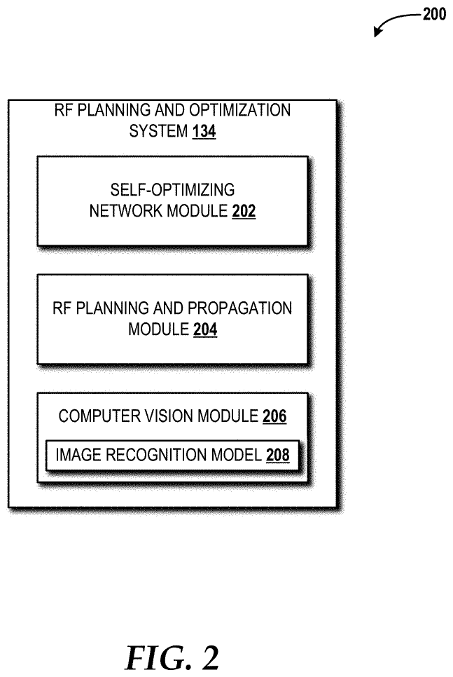

Referring now to FIG. 2, an example RF planning and optimization system architecture 200 illustrating aspects of the RF planning and optimization system 134 will be described, according to an illustrative embodiment. The illustrated RF planning and optimization system architecture 200 includes a self-optimizing network module 202, an RF planning and propagation module 204, and a computer vision module 206. Each of these modules will now be described.

The self-optimizing network module 202 can enable the RF planning and optimization system 134 to communicate with the eNB/gNB 102 to provide instructions as part of the remedial action(s) 158 to perform remote antenna adjustment in an effort to mitigate or eliminate the effects caused by a change at the cell site 108. For example, the self-optimizing network module 202 can determine, based upon the cell site data 139, a change to the antenna configuration 118 (e.g., change the azimuth value 120 and/or the tilt value 122) and/or adjust increase power to the antenna array 114 to optimize signal strength and coverage within the cell site 108.

The RF planning and propagation module 204 can enable the RF planning and optimization system 134 to process the clutter data 154 obtained from the clutter data source(s) 150 and the cell site data 139 obtained from the cell site data collector 138. The RF planning and propagation module 204 can update the clutter data 154 based upon cell site data 139, which can then be disseminated to the clutter data source(s) 150. When temporary RF obstruction(s) 124 are removed, the RF planning and propagation module 204 can again update the clutter data 154 to remove data associated with the temporary RF obstruction(s) 124.

The computer vision module 206 can obtain the model training data 156 from the model training data source(s) 152 and implement a machine learning training process to train an image recognition model 208. As shown in FIG. 1, the RF planning and optimization system 134 can obtain the model training data 156 from one or more model training data sources 152. In some embodiments, the model training data source(s) 152 can include a cell site image database that contains baseline cell site images of a plurality of cell sites, such as the cell site 108 and the neighbor cell sites 110 prior to being upgraded. Moreover, the baseline cell site images can be refined based upon the clutter data 154 obtained from the clutter data source(s) 150.

Turning now to FIG. 3, an example eNB/gNB architecture 300 illustrating aspects of the eNB/gNB 102 introduced above with respect to FIG. 1 will be described. The eNB/gNB 102 illustrated in FIG. 3 includes one or more eNB/gNB processors 302, one or more eNB/gNB memory components 304, one or more baseband units (“BBUs”) 306, one or more remote radio heads (“RRHs”) 308, one or more eNB/gNB operating systems 310, one or more eNB/gNB applications 312, and the antenna system 112, including the antenna array 114 and the antenna software 116. Each of these components will now be described in detail.

An eNB/gNB processor 302 can include one or more processing units configured to process data, execute computer-executable instructions of one or more application programs, and communicate with other components of the eNB/gNB 102 in order to perform various functionality described herein. The eNB/gNB processor 302 may be utilized to execute aspects of the eNB/gNB operating system(s) 310 and the eNB/gNB application(s) 312. In some embodiments, the eNB/gNB processor 302 is or includes a central processing unit (“CPU”), a communications processor, or a field-programmable gate array (“FPGA”). In some embodiments, the eNB/gNB processor 302 is or is included in a system-on-a-chip (“SoC”) along with one or more of the other components described herein below. For example, the SoC may include the eNB/gNB processor 302, a GPU, the BBU(s) 306, the RRH(s) 308, or some combination thereof. In some embodiments, the eNB/gNB processor 302 is fabricated, in part, utilizing a package-on-package (“PoP”) integrated circuit packaging technique. Moreover, the eNB/gNB processor 302 may be a single core or multi-core processor. The eNB/gNB processor 302 may be created in accordance with an ARM architecture, available for license from ARM HOLDINGS of Cambridge, United Kingdom. Alternatively, the eNB/gNB processor 302 may be created in accordance with an x86 architecture, such as is available from INTEL CORPORATION of Mountain View, Calif. and others. In some embodiments, the eNB/gNB processor 302 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an OMAP SoC, available from TEXAS INSTRUMENTS of Dallas, Tex., a customized version of any of the above SoCs, or a proprietary SoC.

The eNB/gNB memory components 304 can include a RAM, a ROM, an integrated storage memory, and a removable storage memory, or some combination thereof. In some embodiments, the eNB/gNB memory components 304 store the eNB/gNB operating system(s) 310 or a portion thereof (e.g., operating system kernel or bootloader), and/or the eNB/gNB application(s) 312.

The BBU 306 is the baseband processing unit of the eNB/gNB 102. The BBU 306 can include other components shown, including, for example, the eNB/gNB processor(s) 302, the eNB/gNB memory component(s) 304, the eNB operating system(s) 310, the eNB/gNB application(s) 312, or some combination thereof. The BBU 306 can receive IP packets from the EPC network 142 and/or the 5G core network 144 (see FIG. 1) and can modulate the IP packets into digital baseband signals. The BBU 306 can send the digital baseband signals to the RRH(s) 308. The digital baseband signals received by the RRH(s) 308 can be demodulated and IP packets can be transmitted to the EPC network 142 and/or the 5G core network 144. The RRH(s) 308 can transmit and receive wireless signals to/from devices such as the mobile device 106. The RRH(s) 308 also convert the digital baseband signals from the BBU 306 that have been subjected to protocol-specific processing into RF signals and power amplifies the signals for transmission to the devices such as the mobile device 106. The RF signals received from the devices are amplified and converted to digital baseband signals for transmission to the BBU 306.

The eNB/gNB operating system 308 is a program for controlling the operation of the eNB/gNB 102. The eNB/gNB operating system 308 can include a proprietary operating system, an embedded operating system, a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

An eNB/gNB application 312 can be any application that performs operations for the eNB/gNB 102. For example, the eNB/gNB application(s) 312 can be or can include software compliant with 3GPP standards for call control processing, performance management, self-organizing network functions, and the like.

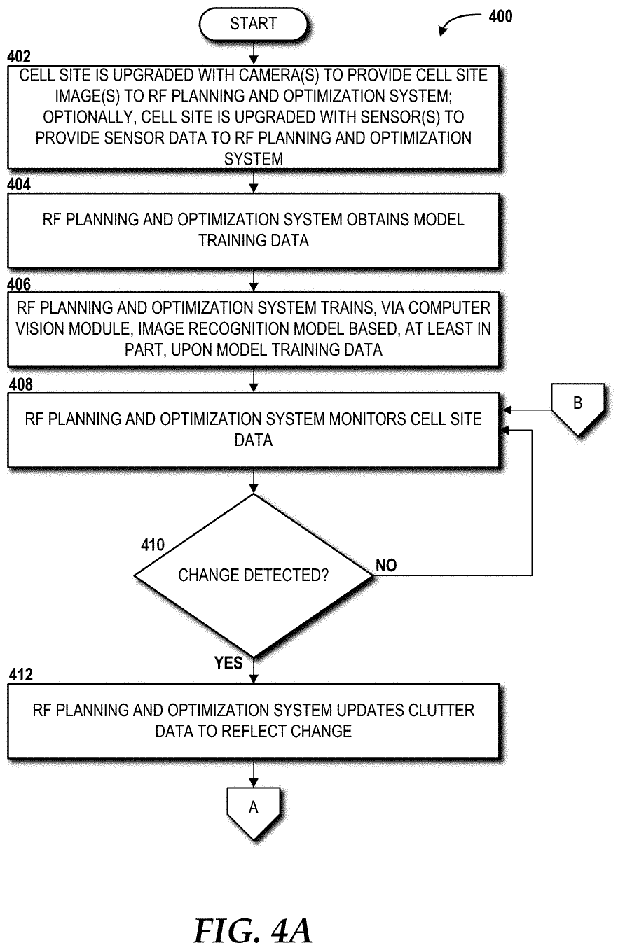

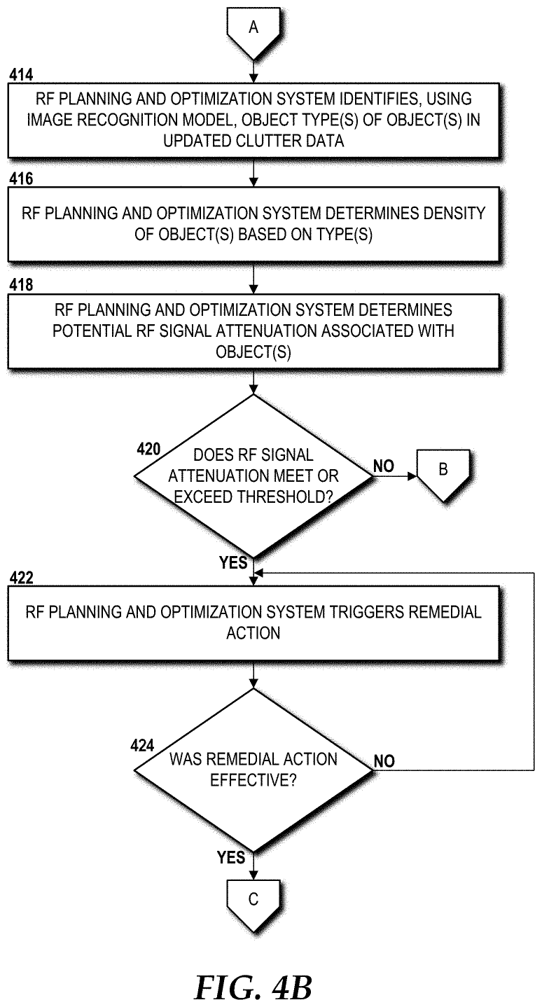

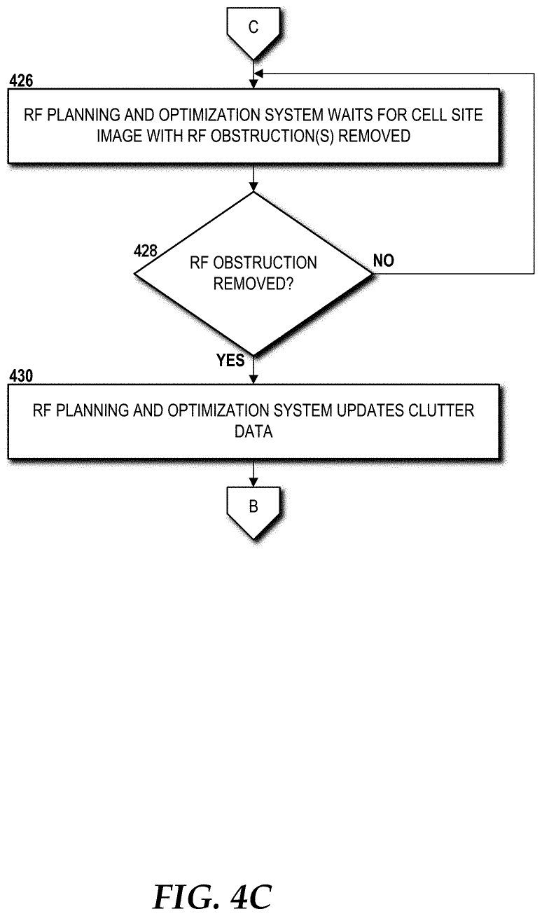

Referring now to FIGS. 4A-4C, a flow diagram illustrating a method 400 for computer vision-based dynamic RF planning and optimization in accordance with the concepts and technologies disclosed herein will be described, according to an illustrative embodiment. The method 400 will be described with reference to FIGS. 4A-4C and further reference to FIGS. 1-3. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing one or more processors disclosed herein to perform operations.

For purposes of illustrating and describing some of the concepts of the present disclosure, operations of the method 400 may be described as being performed, at least in part, by the RF planning and optimization system 134, and/or other network elements, systems, and/or device disclosed herein, via execution, by one or more processors, of one or more software modules. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 400 begins and proceeds to operation 402. At operation 402, the cell site 108 is upgraded with one or more cameras 126 to provide one or more cell site images 132 to the RF planning and optimization system 134. Optionally, at operation 402, the cell site 108 can be further upgraded with one or more sensors 128 to provide sensor data 136 to the RF planning and optimization system 134.

From operation 402, the method 400 proceeds to operation 404. At operation 404, the RF planning and optimization system 134 obtains model training data 156 to train the image recognition model 208 (best shown in FIG. 2). As shown in FIG. 1, the RF planning and optimization system 134 can obtain the model training data 156 from one or more model training data sources 152. In some embodiments, the model training data source(s) 152 include a cell site image database that contains baseline cell site images of a plurality of cell sites, such as the cell site 108 and the neighbor cell sites 110 prior to being upgraded. Moreover, the baseline cell site images can be refined based upon the clutter data 154 obtained from the clutter data source(s) 150. From operation 404, the method 400 proceeds to operation 406. At operation 406, the RF planning and optimization system 134 trains, via the computer vision module 206, the image recognition model 208 based, at least in part, upon the model training data 156.

From operation 406, the method 400 proceeds to operation 408. At operation 408, the RF planning and optimization system 134 monitors the cell site 108 for cell site data 139, including the cell site image(s) 132 and, optionally, the sensor data 136. In the example shown in FIG. 1, the cell site 108 includes a cell site data collector 138 that is configured to aggregate output of the camera(s) 126 and the sensor(s) 128 for sending to the RF planning and optimization system 134. In some embodiments, the cell site data collector 138 may prepare the cell site data 139, including compressing the cell site data 139, formatting the cell site data 139, encrypting the cell site data 139, or otherwise manipulating the cell site data 139 prior to transferring the cell site data 139 to the RF planning and optimization system 134. In some embodiments, the cell site data collector 138 provides the cell site data 139 to the RF planning and optimization system 134 via a dedicated channel. It is contemplated that the cell site data collector 138 may provide the cell site data 139 to the RF planning and optimization system 134 via a backhaul connection, which may be shared with other backhaul communications or dedicated for providing the cell site data 139 to the RF planning and optimization system 134.

From operation 408, the method 400 proceeds to operation 410. At operation 410, the RF planning and optimization system 134 determines whether a change at the cell site 108 has been detected. In particular, the RF planning and optimization system 134 can feed the cell site image 132 into the computer vision module 206, which can execute the image recognition model 208 to determine whether a change has been made to the cell site 108. A change can be effected by one or more RF obstructions 124 that change the RF characteristics of the cell site 108. Although the change may be permanent or semi-permanent, such as landscaping that adds additional trees or the construction of a new building, the concepts and technologies disclosed herein find particular application to changes that are temporary. For example, a fair may cause temporary RF obstructions 124 in the form of ride equipment, tents, other structures, and/or the like. During initial RF planning for a cell site 108 that serves the area in which the fair is located, the mobile network operator did not have clutter data 154 representative of these temporary structures. Moreover, map data would not have data representative of these temporary structures.

If, at operation 410, the RF planning and optimization system 134 detects a change at the cell site 108, the method 400 can proceed to operation 412. At operation 412, the computer vision module 206 can update the clutter data 154 to reflect the change. The RF planning and optimization system 134 can send the updated clutter data 154 to the clutter data source(s) 150, which can disseminate the updated clutter data 154, as needed, to other cell sites such as the neighbor cell sites 110. Returning to operation 410, if instead the RF planning and optimization system 134 does not detect a change at the cell site 108, the method 400 can proceed back to operation 408 and the RF planning and optimization system 134 can resume monitoring the cell site data 139.

From operation 412, the method 400 proceeds to operation 414 shown in FIG. 4B. At operation 414, the RF planning and optimization system 134 can identify, using the image recognition model 208, an object type of an object in the clutter data 154. The object can be the RF obstruction 124 or a portion thereof. For example, the object type may be a known object type such as a tree or a structure made from a particular material (e.g., wood, brick, or metal) or combination of materials. From operation 414, the method 400 proceeds to operation 416. At operation 416, the RF planning and optimization system 134 determines a density of the object based upon the object type. The density can be determined based upon standard density values associated with object types and/or based upon the sensor data 136 (e.g., lidar data). From operation 416, the method 400 proceeds to operation 418. At operation 418, the RF planning and optimization system 134 determines a potential RF signal attenuation associated with the object. The potential RF signal attenuation can be based upon standard RF signal attenuation values for the density determined at operation 416.

From operation 418, the method 400 proceeds to operation 420. At operation 420, the RF planning and optimization system 134 determines whether the RF signal attenuation meets or exceeds a threshold. For example, the mobile network operator can define a threshold value for RF signal attenuation that is acceptable prior to taking any remedial action. If the RF signal attenuation does not meet or exceed the threshold value, the method 400 can return to operation 408 shown in FIG. 4A. At operation 408, the RF planning and optimization system 134 can resume monitoring the cell site data 139. If, however, at operation 420, the RF planning and optimization system 134 determines that the RF signal attenuation meets or exceeds the threshold value, the method 400 proceeds to operation 422. At operation 422, the RF planning and optimization system 134 triggers one or more remedial actions 158 to be taken. The remedial action(s) 158 can be or can include a remote antenna adjustment to the antenna array 114 of the antenna system 112 deployed at the cell site 108, such as a change that affects the azimuth value 120 and/or the tilt value 122 of one or more antennas in the antenna array 114. The remedial action(s) 158 can be or can include a change to the transmit power of the eNB/gNB 102. The remedial action(s) 158 can be or can include a deployment of additional cell resources, such as temporary small cells, which may be terrestrial or aerial (e.g., drone-based). Those skilled in the art will appreciate that other remedial actions can be taken to mitigate or eliminate the effects caused by the change at the cell site 108.

From operation 422, the method 400 proceeds to operation 424. At operation 424, the RF planning and optimization system 134 determines whether the remedial action(s) 158 were effective to reduce the RF signal attenuation to below the threshold value. If not, the method 400 returns to operation 422, where the RF planning and optimization system 134 can trigger another remedial action 158. The method 400 may continually trigger remedial actions 158 until effective or else a specified number of attempts have been made or the available remedial actions 158 have been exhausted. If, at operation 424, the RF planning and optimization system 134 instead determines that the remedial action(s) 158 were effective, the method 400 proceeds to operation 426 shown in FIG. 4C.

Turning to FIG. 4C, and particularly operation 426, the RF planning and optimization system 134 waits for a cell site image 132 with the RF obstruction(s) 124 removed. From operation 426, the method 400 proceeds to operation 428. At operation 428, the RF planning and optimization system 134 determines whether the RF obstruction 124 has been removed from the cell site 108. If not, the method 400 reverts back to operation 426 and the RF planning and optimization system 134 continues to wait for a cell site image 132 with the RF obstruction(s) 124 removed. If instead the RF planning and optimization system 134 determines that the RF obstruction 124 has been removed, the method 400 proceeds to operation 430. At operation 430, the RF planning and optimization system 134 updates the clutter data 154 and provides the updated clutter data 154 to the clutter data source(s) 150. From operation 430, the method 400 reverts back to operation 408 and the method 400 proceeds as described above.

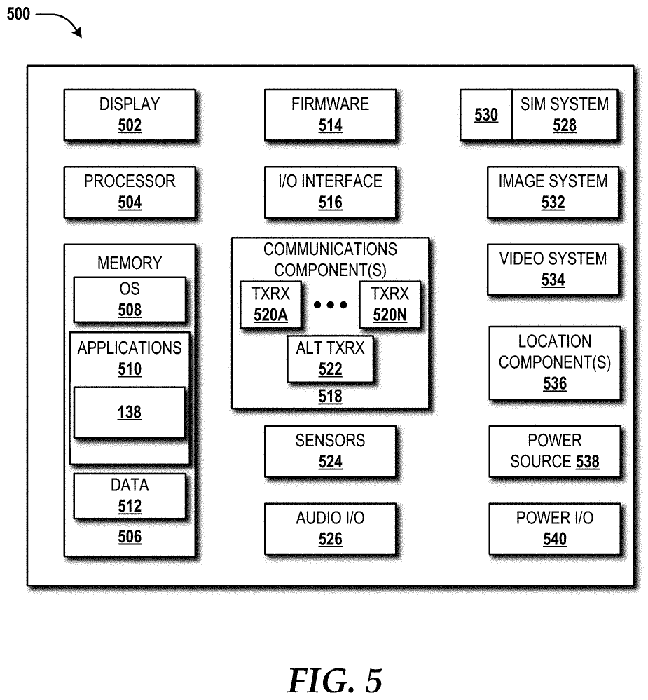

Turning now to FIG. 5, an illustrative mobile device 500 and components thereof will be described. In some embodiments, the mobile device 106 described above with reference to FIG. 1 can be configured as and/or can have an architecture similar or identical to the mobile device 500 described herein in FIG. 5. It should be understood, however, that the mobile device 106 may or may not include the functionality described herein with reference to FIG. 5. While connections are not shown between the various components illustrated in FIG. 5, it should be understood that some, none, or all of the components illustrated in FIG. 5 can be configured to interact with one another to carry out various device functions. In some embodiments, the components are arranged so as to communicate via one or more busses (not shown). Thus, it should be understood that FIG. 5 and the following description are intended to provide a general understanding of a suitable environment in which various aspects of embodiments can be implemented, and should not be construed as being limiting in any way.

As illustrated in FIG. 5, the mobile device 500 can include a display 502 for displaying data. According to various embodiments, the display 502 can be configured to display network connection information, various GUI elements, text, images, video, virtual keypads and/or keyboards, messaging data, notification messages, metadata, Internet content, device status, time, date, calendar data, device preferences, map and location data, combinations thereof, and/or the like. The mobile device 500 also can include a processor 504 and a memory or other data storage device (“memory”) 506. The processor 504 can be configured to process data and/or can execute computer-executable instructions stored in the memory 506. The computer-executable instructions executed by the processor 504 can include, for example, an operating system 508, one or more applications 510, other computer-executable instructions stored in the memory 506, or the like. In some embodiments, the applications 510 also can include a UI application (not illustrated in FIG. 5).

The UI application can interface with the operating system 508 to facilitate user interaction with functionality and/or data stored at the mobile device 500 and/or stored elsewhere. In some embodiments, the operating system 508 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 504 to aid a user in data communications, entering/deleting data, entering and setting user IDs and passwords for device access, configuring settings, manipulating content and/or settings, multimode interaction, interacting with other applications 510, and otherwise facilitating user interaction with the operating system 508, the applications 510, and/or other types or instances of data 512 that can be stored at the mobile device 500.

The applications 510, the data 512, and/or portions thereof can be stored in the memory 506 and/or in a firmware 514, and can be executed by the processor 504. The firmware 514 also can store code for execution during device power up and power down operations. It can be appreciated that the firmware 514 can be stored in a volatile or non-volatile data storage device including, but not limited to, the memory 506 and/or a portion thereof.

The mobile device 500 also can include an input/output (“I/O”) interface 516. The I/O interface 516 can be configured to support the input/output of data such as location information, presence status information, user IDs, passwords, and application initiation (start-up) requests. In some embodiments, the I/O interface 516 can include a hardwire connection such as a universal serial bus (“USB”) port, a mini-USB port, a micro-USB port, an audio jack, a PS2 port, an IEEE 1395 (“FIREWIRE”) port, a serial port, a parallel port, an Ethernet (RJ45) port, an RJ11 port, a proprietary port, combinations thereof, or the like. In some embodiments, the mobile device 500 can be configured to synchronize with another device to transfer content to and/or from the mobile device 500. In some embodiments, the mobile device 500 can be configured to receive updates to one or more of the applications 510 via the I/O interface 516, though this is not necessarily the case. In some embodiments, the I/O interface 516 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 516 may be used for communications between the mobile device 500 and a network device or local device.

The mobile device 500 also can include a communications component 518. The communications component 518 can be configured to interface with the processor 504 to facilitate wired and/or wireless communications with one or more networks. In some embodiments, the communications component 518 includes a multimode communications subsystem for facilitating communications via the cellular network and one or more other networks.

The communications component 518, in some embodiments, includes one or more transceivers. The one or more transceivers, if included, can be configured to communicate over the same and/or different wireless technology standards with respect to one another. For example, in some embodiments, one or more of the transceivers of the communications component 518 may be configured to communicate using GSM, CDMAONE, CDMA2000, LTE, and various other 2G, 2.5G, 3G, 4G, 4.5G, 5G, and greater generation technology standards. Moreover, the communications component 518 may facilitate communications over various channel access methods (which may or may not be used by the aforementioned standards) including, but not limited to, TDMA, FDMA, W-CDMA, OFDM, SDMA, and the like.

In addition, the communications component 518 may facilitate data communications using GPRS, EDGE, the HSPA protocol family including HSDPA, EUL or otherwise termed HSUPA, HSPA+, and various other current and future wireless data access standards. In the illustrated embodiment, the communications component 518 can include a first transceiver (“TxRx”) 520A that can operate in a first communications mode (e.g., GSM). The communications component 518 also can include an Nth transceiver (“TxRx”) 520N that can operate in a second communications mode relative to the first transceiver 520A (e.g., UMTS). While two transceivers 520A-520N (hereinafter collectively and/or generically referred to as “transceivers 520”) are shown in FIG. 5, it should be appreciated that less than two, two, and/or more than two transceivers 520 can be included in the communications component 518.

The communications component 518 also can include an alternative transceiver (“Alt TxRx”) 522 for supporting other types and/or standards of communications. According to various contemplated embodiments, the alternative transceiver 522 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 518 also can facilitate reception from terrestrial radio networks, digital satellite radio networks, internet-based radio service networks, combinations thereof, and the like. The communications component 518 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 500 also can include one or more sensors 524. The sensors 524 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 500 may be provided by an audio I/O component 526. The audio I/O component 526 of the mobile device 500 can include one or more speakers for the output of audio signals, one or more microphones for the collection and/or input of audio signals, and/or other audio input and/or output devices.

The illustrated mobile device 500 also can include a subscriber identity module (“SIM”) system 528. The SIM system 528 can include a universal SIM (“USIM”), a universal integrated circuit card (“UICC”) and/or other identity devices. The SIM system 528 can include and/or can be connected to or inserted into an interface such as a slot interface 530. In some embodiments, the slot interface 530 can be configured to accept insertion of other identity cards or modules for accessing various types of networks. Additionally, or alternatively, the slot interface 530 can be configured to accept multiple subscriber identity cards. Because other devices and/or modules for identifying users and/or the mobile device 500 are contemplated, it should be understood that these embodiments are illustrative, and should not be construed as being limiting in any way.

The mobile device 500 also can include an image capture and processing system 532 (“image system”). The image system 532 can be configured to capture or otherwise obtain photos, videos, and/or other visual information. As such, the image system 532 can include cameras, lenses, charge-coupled devices (“CCDs”), combinations thereof, or the like. The mobile device 500 may also include a video system 534. The video system 534 can be configured to capture, process, record, modify, and/or store video content. Photos and videos obtained using the image system 532 and the video system 534, respectively, may be added as message content to an MMS message, email message, and sent to another device. The video and/or photo content also can be shared with other devices via various types of data transfers via wired and/or wireless communication devices as described herein.

The mobile device 500 also can include one or more location components 536. The location components 536 can be configured to send and/or receive signals to determine a geographic location of the mobile device 500. According to various embodiments, the location components 536 can send and/or receive signals from global positioning system (“GPS”) devices, assisted-GPS (“A-GPS”) devices, WI-FI/WIMAX and/or cellular network triangulation data, combinations thereof, and the like. The location component 536 also can be configured to communicate with the communications component 518 to retrieve triangulation data for determining a location of the mobile device 500. In some embodiments, the location component 536 can interface with cellular network nodes, telephone lines, satellites, location transmitters and/or beacons, wireless network transmitters and receivers, combinations thereof, and the like. In some embodiments, the location component 536 can include and/or can communicate with one or more of the sensors 524 such as a compass, an accelerometer, and/or a gyroscope to determine the orientation of the mobile device 500. Using the location component 536, the mobile device 500 can generate and/or receive data to identify its geographic location, or to transmit data used by other devices to determine the location of the mobile device 500. The location component 536 may include multiple components for determining the location and/or orientation of the mobile device 500.

The illustrated mobile device 500 also can include a power source 538. The power source 538 can include one or more batteries, power supplies, power cells, and/or other power subsystems including alternating current (“AC”) and/or direct current (“DC”) power devices. The power source 538 also can interface with an external power system or charging equipment via a power I/O component 540. Because the mobile device 500 can include additional and/or alternative components, the above embodiment should be understood as being illustrative of one possible operating environment for various embodiments of the concepts and technologies described herein. The described embodiment of the mobile device 500 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

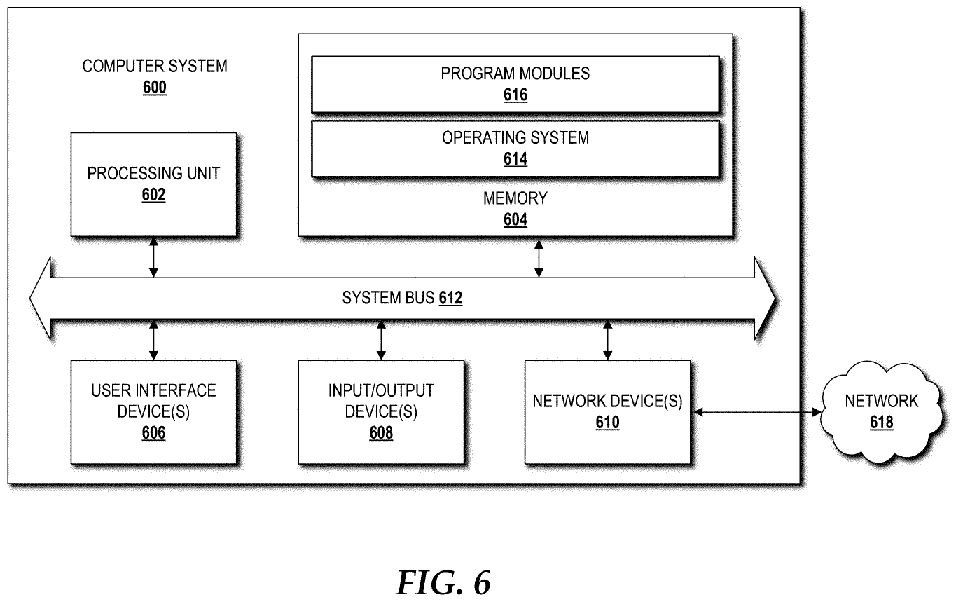

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 500 or other devices or computers described herein, such as the computer system 600 described above with reference to FIG. 6. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 500 in order to store and execute the software components presented herein. It is also contemplated that the mobile device 500 may not include all of the components shown in FIG. 5, may include other components that are not explicitly shown in FIG. 5, or may utilize an architecture completely different than that shown in FIG. 5.

Turning now to FIG. 6 is a block diagram illustrating a computer system 600 configured to provide the functionality in accordance with various embodiments of the concepts and technologies disclosed herein. The systems, devices, and other components disclosed herein, such as the RF planning and optimization system 134, can be implemented, at least in part, using an architecture that is the same as or similar to the architecture of the computer system 600. It should be understood, however, that modification to the architecture may be made to facilitate certain interactions among elements described herein.

The computer system 600 includes a processing unit 602, a memory 604, one or more user interface devices 606, one or more input/output (“I/O”) devices 608, and one or more network devices 610, each of which is operatively connected to a system bus 612. The bus 612 enables bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. Processing units are generally known, and therefore are not described in further detail herein.

The memory 604 communicates with the processing unit 602 via the system bus 612. In some embodiments, the memory 604 is operatively connected to a memory controller (not shown) that enables communication with the processing unit 602 via the system bus 612. The illustrated memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, OS X, and/or iOS families of operating systems from APPLE CORPORATION, the FREEBSD family of operating systems, the SOLARIS family of operating systems from ORACLE CORPORATION, other operating systems, and the like.

The program modules 616 may include various software and/or program modules to perform the various operations described herein. The program modules 616 and/or other programs can be embodied in computer-readable media containing instructions that, when executed by the processing unit 602, perform various operations such as those described herein. According to embodiments, the program modules 616 may be embodied in hardware, software, firmware, or any combination thereof

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium,” “computer-readable storage medium,” and variations thereof does not include waves or signals per se and/or communication media, and therefore should be construed as being directed to “non-transitory” media only.

The user interface devices 606 may include one or more devices with which a user accesses the computer system 600. The user interface devices 606 may include, but are not limited to, computers, servers, PDAs, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer. In some embodiments, the I/O devices 608 can be used for manual controls for operations to exercise under certain emergency situations.

The network devices 610 enable the computer system 600 to communicate with other networks or remote systems via a network 618, such as the RAN 104, the core networks 140, and/or the other networks 146. Examples of the network devices 610 include, but are not limited to, a modem, a radio frequency (“RF”) or infrared (“IR”) transceiver, a telephonic interface, a bridge, a router, or a network card. The network 618 may be or may include a wireless network such as, but not limited to, a Wireless Local Area Network (“WLAN”), a Wireless Wide Area Network (“WWAN”), a Wireless Personal Area Network (“WPAN”) such as provided via BLUETOOTH technology, a Wireless Metropolitan Area Network (“WMAN”) such as a WiMAX network or metropolitan cellular network. Alternatively, the network 618 may be or may include a wired network such as, but not limited to, a Wide Area Network (“WAN”), a wired Personal Area Network (“PAN”), or a wired Metropolitan Area Network (“MAN”).

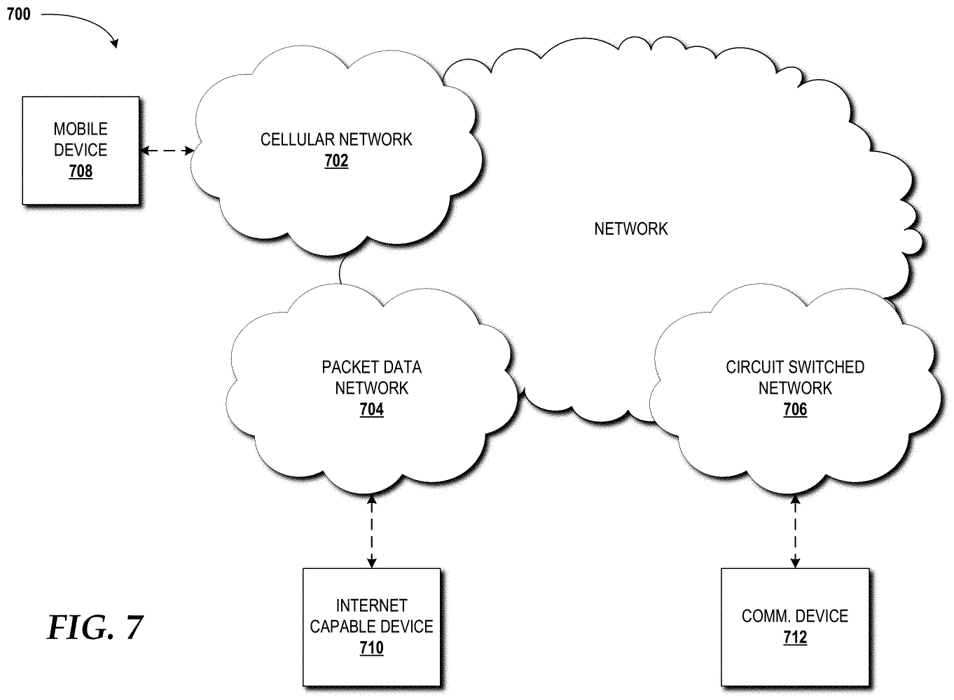

Turning now to FIG. 7, details of a network 700 are illustrated, according to an illustrative embodiment. In some embodiments, the network 700 can include the RAN 104, the core networks 140, and/or other networks 146. The network 700 includes a cellular network 702, a packet data network 704, for example, the Internet, and a circuit switched network 706, for example, a public switched telephone network (“PSTN”). The cellular network 702 includes various components such as, but not limited to, base transceiver stations (“BTSs”), NBs or eNBs, combination eNB/gNB such as the eNB/gNB 102, base station controllers (“BSCs”), radio network controllers (“RNCs”), mobile switching centers (“MSCs”), MMEs, short message service centers (“SMSCs”), multimedia messaging service centers (“MMSCs”), home location registers (“HLRs”), HSSs, VLRs”), charging platforms, billing platforms, voicemail platforms, GPRS core network components, location service nodes, an IP Multimedia Subsystem (”IMS″), and the like. The cellular network 702 also includes radios and nodes for receiving and transmitting voice, data, and combinations thereof to and from radio transceivers, networks, the packet data network 704, and the circuit switched network 706.

A mobile communications device 708, such as, for example, the mobile device 106, a cellular telephone, a user equipment, a mobile terminal, a PDA, a laptop computer, a handheld computer, and combinations thereof, can be operatively connected to the cellular network 702. The cellular network 702 can be configured as a 2G GSM network and can provide data communications via GPRS and/or EDGE. Additionally, or alternatively, the cellular network 702 can be configured as a 3G UMTS network and can provide data communications via the HSPA protocol family, for example, HSDPA, EUL (also referred to as HSUPA), and HSPA+. The cellular network 702 also is compatible with 4G mobile communications standards such as LTE, or the like, as well as evolved and future mobile standards.

The packet data network 704 includes various devices, for example, servers, computers, databases, and other devices in communication with another, as is generally known. The packet data network 704 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 704 includes or is in communication with the Internet. The circuit switched network 706 includes various hardware and software for providing circuit switched communications. The circuit switched network 706 may include, or may be, what is often referred to as a plain old telephone system (“POTS”). The functionality of a circuit switched network 706 or other circuit-switched network are generally known and will not be described herein in detail.

The illustrated cellular network 702 is shown in communication with the packet data network 704 and a circuit switched network 706, though it should be appreciated that this is not necessarily the case. One or more Internet-capable devices 710, for example, a PC, a laptop, a portable device, or another suitable device, can communicate with one or more cellular networks 702, and devices connected thereto, through the packet data network 704. It also should be appreciated that the Internet-capable device 710 can communicate with the packet data network 704 through the circuit switched network 706, the cellular network 702, and/or via other networks (not illustrated).

As illustrated, a communications device 712, for example, a telephone, facsimile machine, modem, computer, or the like, can be in communication with the circuit switched network 706, and therethrough to the packet data network 704 and/or the cellular network 702. It should be appreciated that the communications device 712 can be an Internet-capable device, and can be substantially similar to the Internet-capable device 710. In the specification, the network is used to refer broadly to any combination of the networks 702, 704, 706 shown in FIG. 7. It should be appreciated that substantially all of the functionality described with reference to the RAN 104, the core networks 140, and the other networks 146 can be performed by the cellular network 702, the packet data network 704, and/or the circuit switched network 706, alone or in combination with other networks, network elements, and the like.

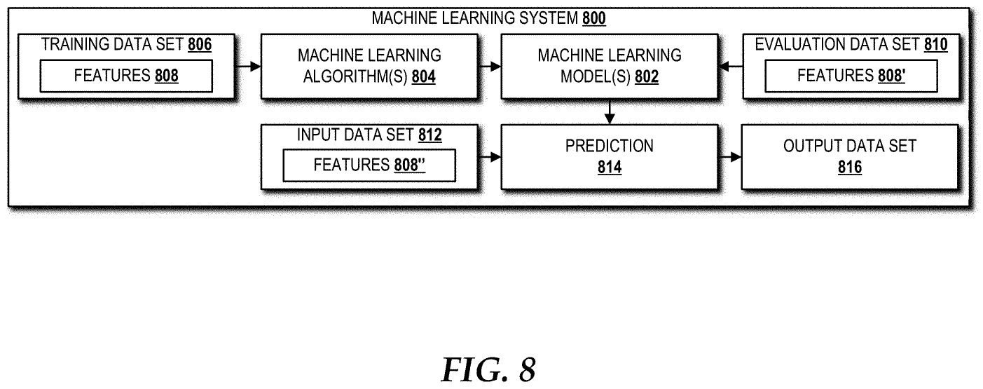

Turning now to FIG. 8, a machine learning system 800 capable of implementing aspects of the embodiments disclosed herein will be described. In some embodiments, the RF planning and optimization system 134 can implement or otherwise utilize a machine learning system such as the machine learning system 800. The illustrated machine learning system 800 includes one or more machine learning models 802, such as the image recognition model 208. The machine learning models 802 can include supervised and/or semi-supervised learning models. The machine learning model(s) 802 can be created by the machine learning system 800 based upon one or more machine learning algorithms 804. The machine learning algorithm(s) 804 can be any existing, well-known algorithm, any proprietary algorithms, or any future machine learning algorithm. Some example machine learning algorithms 804 include, but are not limited to, gradient descent, linear regression, logistic regression, linear discriminant analysis, classification tree, regression tree, Naive Bayes, K-nearest neighbor, learning vector quantization, support vector machines, and the like. Classification and regression algorithms might find particular applicability to the concepts and technologies disclosed herein. Those skilled in the art will appreciate the applicability of various machine learning algorithms 804 based upon the problem(s) to be solved by machine learning via the machine learning system 800.

The machine learning system 800 can control the creation of the machine learning models 802 via one or more training parameters. In some embodiments, the training parameters are selected modelers at the direction of an enterprise, for example. Alternatively, in some embodiments, the training parameters are automatically selected based upon data provided in one or more training data sets 806, such as the model training data 156 from the model training data source(s) 152. The training parameters can include, for example, a learning rate, a model size, a number of training passes, data shuffling, regularization, and/or other training parameters known to those skilled in the art.

The learning rate is a training parameter defined by a constant value. The learning rate affects the speed at which the machine learning algorithm 804 converges to the optimal weights. The machine learning algorithm 804 can update the weights for every data example included in the training data set 806. The size of an update is controlled by the learning rate. A learning rate that is too high might prevent the machine learning algorithm 804 from converging to the optimal weights. A learning rate that is too low might result in the machine learning algorithm 804 requiring multiple training passes to converge to the optimal weights.

The model size is regulated by the number of input features (“features”) 806 in the training data set 806. A greater the number of features 808 yields a greater number of possible patterns that can be determined from the training data set 806. The model size should be selected to balance the resources (e.g., compute, memory, storage, etc.) needed for training and the predictive power of the resultant machine learning model 802.

The number of training passes indicates the number of training passes that the machine learning algorithm 804 makes over the training data set 806 during the training process. The number of training passes can be adjusted based, for example, on the size of the training data set 806, with larger training data sets being exposed to fewer training passes in consideration of time and/or resource utilization. The effectiveness of the resultant machine learning model 802 can be increased by multiple training passes.

Data shuffling is a training parameter designed to prevent the machine learning algorithm 804 from reaching false optimal weights due to the order in which data contained in the training data set 806 is processed. For example, data provided in rows and columns might be analyzed first row, second row, third row, etc., and thus an optimal weight might be obtained well before a full range of data has been considered. By data shuffling, the data contained in the training data set 806 can be analyzed more thoroughly and mitigate bias in the resultant machine learning model 802.

Regularization is a training parameter that helps to prevent the machine learning model 802 from memorizing training data from the training data set 806. In other words, the machine learning model 802 fits the training data set 806, but the predictive performance of the machine learning model 802 is not acceptable. Regularization helps the machine learning system 800 avoid this overfitting/memorization problem by adjusting extreme weight values of the features 808. For example, a feature that has a small weight value relative to the weight values of the other features in the training data set 806 can be adjusted to zero.

The machine learning system 800 can determine model accuracy after training by using one or more evaluation data sets 810 containing the same features 808′ as the features 808 in the training data set 806. This also prevents the machine learning model 802 from simply memorizing the data contained in the training data set 806. The number of evaluation passes made by the machine learning system 800 can be regulated by a target model accuracy that, when reached, ends the evaluation process and the machine learning model 802 is considered ready for deployment.

After deployment, the machine learning model 802 can perform a prediction operation (“prediction”) 814 with an input data set 812 having the same features 808″ as the features 808 in the training data set 806 and the features 808′ of the evaluation data set 810. The results of the prediction 814 are included in an output data set 816 consisting of predicted data. The machine learning model 802 can perform other operations, such as regression, classification, and others. As such, the example illustrated in FIG. 8 should not be construed as being limiting in any way.

Turning now to FIG. 9, a block diagram illustrating an example virtualized cloud architecture 900 and components thereof will be described, according to an exemplary embodiment. In some embodiments, the virtualized cloud architecture 900 can be utilized to implement, at least in part, the core networks 140, the RAN 104, the RF planning and optimization system 134, the other network(s) 146, the model training data sources 152, the clutter data sources 150, or portions thereof. The virtualized cloud architecture 900 is a shared infrastructure that can support multiple services and network applications. The illustrated virtualized cloud architecture 900 includes a hardware resource layer 902, a control layer 904, a virtual resource layer 906, and an application layer 908 that work together to perform operations as will be described in detail herein.

The hardware resource layer 902 provides hardware resources, which, in the illustrated embodiment, include one or more compute resources 910, one or more memory resources 912, and one or more other resources 914. The compute resource(s) 910 can include one or more hardware components that perform computations to process data, and/or to execute computer-executable instructions of one or more application programs, operating systems, and/or other software. The compute resources 910 can include one or more central processing units (“CPUs”) configured with one or more processing cores. The compute resources 910 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 910 can include one or more discrete GPUs. In some other embodiments, the compute resources 910 can include CPU and GPU components that are configured in accordance with a co-processing CPU/GPU computing model, wherein the sequential part of an application executes on the CPU and the computationally-intensive part is accelerated by the GPU. The compute resources 910 can include one or more system-on-chip (“SoC”) components along with one or more other components, including, for example, one or more of the memory resources 912, and/or one or more of the other resources 914. In some embodiments, the compute resources 910 can be or can include one or more SNAPDRAGON SoCs, available from QUALCOMM; one or more TEGRA SoCs, available from NVIDIA; one or more HUMMINGBIRD SoCs, available from SAMSUNG; one or more Open Multimedia Application Platform (“OMAP”) SoCs, available from TEXAS INSTRUMENTS; one or more customized versions of any of the above SoCs; and/or one or more proprietary SoCs. The compute resources 910 can be or can include one or more hardware components architected in accordance with an advanced reduced instruction set computing (“RISC”) machine (“ARM”) architecture, available for license from ARM HOLDINGS. Alternatively, the compute resources 910 can be or can include one or more hardware components architected in accordance with an x86 architecture, such an architecture available from INTEL CORPORATION of Mountain View, Calif., and others. Those skilled in the art will appreciate the implementation of the compute resources 910 can utilize various computation architectures, and as such, the compute resources 910 should not be construed as being limited to any particular computation architecture or combination of computation architectures, including those explicitly disclosed herein.

The memory resource(s) 912 can include one or more hardware components that perform storage operations, including temporary or permanent storage operations. In some embodiments, the memory resource(s) 912 include volatile and/or non-volatile memory implemented in any method or technology for storage of information such as computer-readable instructions, data structures, program modules, or other data disclosed herein.

Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 910.

The other resource(s) 914 can include any other hardware resources that can be utilized by the compute resources(s) 910 and/or the memory resource(s) 912 to perform operations described herein. The other resource(s) 914 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resource layer 902 can be virtualized by one or more virtual machine monitors (“VMMs”) 916A-916N (also known as “hypervisors”; hereinafter “VMMs 916”) operating within the control layer 904 to manage one or more virtual resources that reside in the virtual resource layer 906. The VMMs 916 can be or can include software, firmware, and/or hardware that alone or in combination with other software, firmware, and/or hardware, manages one or more virtual resources operating within the virtual resource layer 906.

The virtual resources operating within the virtual resource layer 906 can include abstractions of at least a portion of the compute resources 910, the memory resources 912, the other resources 914, or any combination thereof. These abstractions are referred to herein as virtual machines (“VMs”). In the illustrated embodiment, the virtual resource layer 906 includes VMs 918A-918N (hereinafter “VMs 918”). Each of the VMs 918 can execute one or more applications 920A-920N in the application layer 908.

Based on the foregoing, it should be appreciated that concepts and technologies directed to computer vision-based dynamic radio frequency planning and optimization have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
monitoring, by a radio frequency (“RF”) planning and optimization system comprising a processor, cell site data from a cell site;
determining, by the RF planning and optimization system, that the cell site data represents a change to the cell site;
in response to determining that the cell site data represents the change to the cell site, updating, by the RF planning and optimization system, clutter data associated with the cell site to reflect the change;
identifying, by the RF planning and optimization system using an image recognition model, an object type of an object in the clutter data;
determining, by the RF planning and optimization system, a potential RF signal attenuation associated with the object;
determining, by the RF planning and optimization system, that the potential RF signal attenuation associated with the object meets or exceeds a threshold; and
triggering, by the RF planning and optimization system, a remedial action to mitigate the potential RF signal attenuation in response to determining that the potential RF signal attenuation meets or exceeds the threshold.

2. The method of claim 1, further comprising:
obtaining, by the RF planning and optimization system, model training data to train the image recognition model; and
training, by the RF planning and optimization system, the image recognition model based, at least in part, upon the model training data.

3. The method of claim 2, wherein the model training data comprises a plurality of baseline cell site images.

4. The method of claim 1, wherein monitoring, by the RF planning and optimization system, the cell site data from the cell site comprises monitoring, by the RF planning and optimization system, a cell site image captured by a camera located at the cell site.

5. The method of claim 4, wherein monitoring, by the RF planning and optimization system, the cell site data from the cell site further comprises monitoring, by the RF planning and optimization system, sensor data captured by a sensor located at the cell site.

6. The method of claim 1, wherein determining, by the RF planning and optimization system, the potential RF signal attenuation associated with the object comprises determining, by the RF planning and optimization system, a density of the object, wherein the potential RF signal attenuation is based, at least in part, upon the density of the object.

7. The method of claim 1, wherein triggering, by the RF planning and optimization system, the remedial action to mitigate the potential RF signal attenuation comprises triggering, by the RF planning and optimization system, a remote antenna adjustment to an antenna array of the cell site.

8. A system comprising:
a processor;
a memory comprising instructions that, when executed by the processor, cause the processor to perform operations comprising
monitoring cell site data from a cell site,
determining that the cell site data represents a change to the cell site,
in response to determining that the cell site data represents the change to the cell site, updating clutter data associated with the cell site to reflect the change,
identifying, using an image recognition model, an object type of an object in the clutter data,
determining a potential RF signal attenuation associated with the object,
determining the potential RF signal attenuation associated with the object meets or exceeds a threshold, and
triggering a remedial action to mitigate the potential RF signal attenuation in response to determining that the potential RF signal attenuation meets or exceeds the threshold.

9. The system of claim 8, wherein the operations further comprise:
obtaining model training data to train the image recognition model; and
training the image recognition model based, at least in part, upon the model training data.

10. The system of claim 9, wherein the model training data comprises a plurality of baseline cell site images.

11. The system of claim 8, wherein monitoring the cell site data from the cell site comprises monitoring a cell site image captured by a camera located at the cell site.

12. The system of claim 11, wherein monitoring the cell site data from the cell site further comprises monitoring sensor data captured by a sensor located at the cell site.

13. The system of claim 8, wherein determining the potential RF signal attenuation associated with the object comprises determining a density of the object, wherein the potential RF signal attenuation is based, at least in part, upon the density of the object.

14. The system of claim 8, wherein triggering the remedial action to mitigate the potential RF signal attenuation comprises triggering a remote antenna adjustment to an antenna array of the cell site.

15. A computer-readable storage medium comprising computer-executable instructions that, when executed by a processor, cause the processor to perform operations comprising:
monitoring cell site data from a cell site;
determining that the cell site data represents a change to the cell site;
in response to determining that the cell site data represents the change to the cell site, updating clutter data associated with the cell site to reflect the change;
identifying, using an image recognition model, an object type of an object in the clutter data;
determining a potential RF signal attenuation associated with the object;
determining the potential RF signal attenuation associated with the object meets or exceeds a threshold; and
triggering a remedial action to mitigate the potential RF signal attenuation in response to determining that the potential RF signal attenuation meets or exceeds the threshold.

16. The computer-readable storage medium of claim 15, wherein the operations further comprise:
obtaining model training data to train the image recognition model; and
training the image recognition model based, at least in part, upon the model training data.

17. The computer-readable storage medium of claim 16, wherein the model training data comprises a plurality of baseline cell site images.

18. The computer-readable storage medium of claim 15, wherein monitoring the cell site data from the cell site comprises monitoring a cell site image captured by a camera located at the cell site.

19. The computer-readable storage medium of claim 18, wherein monitoring the cell site data from the cell site further comprises monitoring sensor data captured by a sensor located at the cell site.

20. The computer-readable storage medium of claim 15, wherein triggering the remedial action to mitigate the potential RF signal attenuation comprises triggering a remote antenna adjustment to an antenna array of the cell site.
